(19) United States
(12) Patent Application Publication
(10) Pub. No.: US 2017/0004476 A1
(43) Pub. Date: Jan. 5, 2017

(54) COMMODITY SALES DATA PROCESSING APPARATUS AND METHOD FOR EXECUTING OPENING PROCESSING THEREOF

(71) Applicant: TOSHIBA TEC KABUSHIKI KAISHA, Tokyo (JP)

(72) Inventor: Yoshiaki Suzuki, Fuji (JP)

(21) Appl. No.: 15/187,991

(22) Filed: Jun. 21, 2016

(30) Foreign Application Priority Data
Jun. 30, 2015 (JP) 2015-131881

(51) Int. Cl. G06Q 20/20; G07F 7/02; G06K 19/06; G07G 5/00; G06K 7/10

(52) U.S. Cl. CPC G06Q 20/206; G07G 5/00; G06K 7/10881; G06K 19/06028; G07F 7/025

(57) ABSTRACT

A commodity sales data processing apparatus comprises an input module configured to receive an input of identification information capable of identifying an individual, a commodity sales data processing apparatus opening processing module configured to execute a commodity sales data processing apparatus opening processing in a case in which an individual specified with the identification information input from the input module has authority to execute the commodity sales data processing apparatus opening processing, and a storage control module configured to enable a storage section to store the identification information of the individual who executes the commodity sales data processing apparatus opening processing through the commodity sales data processing apparatus opening processing module.

### CROSS-REFERENCE TO RELATED APPLICATION

This application is based upon and claims the benefit of priority from Japanese Patent Application No. 2015-131881, filed Jun. 30, 2015, the entire contents of which are incorporated herein by reference.

### FIELD

Embodiments described herein relate generally to a commodity sales data processing apparatus and a method for executing an opening processing of the commodity sales data processing apparatus.

### BACKGROUND

In a retail store, a POS (Point Of Sales) terminal is used to carry out a commodity sales registration processing and the like. An operator of the POS terminal carries out an opening processing of the POS terminal as a preparation for opening of the store before the start of business of the store. Specifically, the opening processing of the POS terminal refers to a job including the input of the opening date and time of the POS terminal and the supplement of change to a drawer or an automatic change dispensing machine of the POS terminal.

However, in a conventional POS terminal, the name of an operator who carries out the opening processing of the POS terminal is not recorded although the opening processing of the POS terminal is a job of handling cash.

### DESCRIPTION OF THE DRAWINGS

FIG. 1 is an external perspective view illustrating a POS terminal;

FIG. 2 is a block diagram illustrating an example of the hardware structure of the POS terminal;

FIG. 3 is a view illustrating an example of the data structure of a person in charge table;

FIG. 4 is a view illustrating an example of the data structure of a POS terminal opening information table;

FIG. 5 is a block diagram illustrating the functional components of the POS terminal;

FIG. 6 is a view illustrating an example of a person in charge setting screen;

FIG. 7 is a view illustrating an example of a biometric authentication setting screen;

FIG. 8 is a flowchart illustrating the flow of a POS terminal opening processing;

FIG. 9 is a flowchart illustrating the flow of a sign-on processing;

FIG. 10 is a view illustrating an example of a person in charge registration screen;

FIG. 11 is a view illustrating an example of a biometric authentication information input screen; and

FIG. 12 is a view illustrating an example of a POS terminal opening receipt.

### DETAILED DESCRIPTION

In accordance with an embodiment, a commodity sales data processing apparatus comprises an input module, a commodity sales data processing apparatus opening processing module and a storage control module. The input module receives an input of identification information capable of identifying an individual. The commodity sales data processing apparatus opening processing module executes a commodity sales data processing apparatus opening processing in a case in which an individual specified with the identification information input from the input module has authority to execute the commodity sales data processing apparatus opening processing. The storage control module enables a storage section to store the identification information of the individual who executes the commodity sales data processing apparatus opening processing through the commodity sales data processing apparatus opening processing module.

An embodiment of a commodity sales data processing apparatus and a method for recording an individual is described below in detail with reference to the accompanying drawings. The embodiment described below is only one embodiment of the commodity sales data processing apparatus and the method, and the structure and specification thereof are not limited. The present embodiment is an application example to a POS (Point Of Sales) system, introduced to a store such as a supermarket, which carries out a registration and settlement of commodities relating to one transaction.

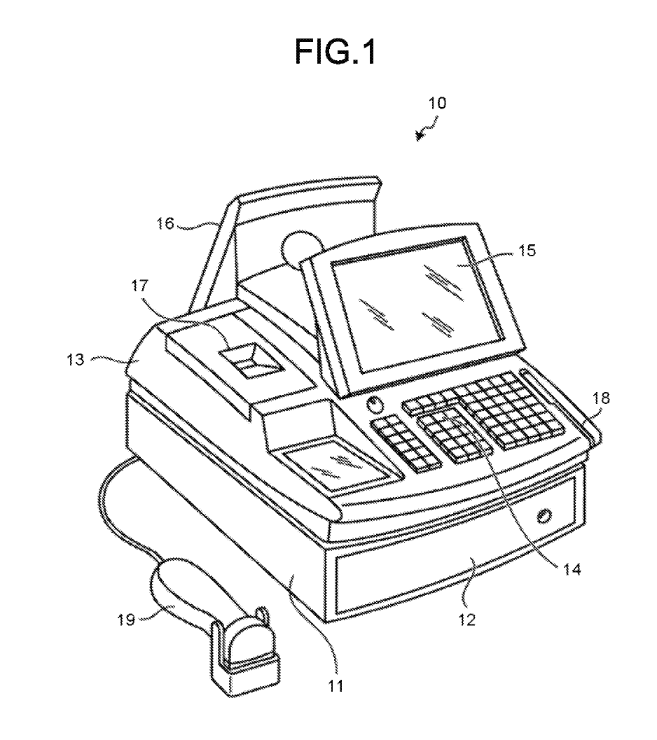

FIG. 1 is an external perspective view illustrating a POS terminal 10. The POS terminal 10 is a commodity sales data processing apparatus for executing a commodity sales data processing. The POS terminal 10, placed on a drawer 11, can control an opening operation of a drawer case 12 of the drawer 11. The drawer 11 stores cash received from a customer and cash used for change in the drawer case 12. Further, the POS terminal 10 may be equipped with an automatic change dispensing machine together with the drawer 11 or instead of the drawer 11. A main body housing 13 of the POS terminal 10 includes a keyboard 14 and a first display section 15 at the right side of the upper surface thereof in FIG. 1.

The keyboard 14 includes numeric keys, a commodity code key, a clear key, a return key and a subtotal key. The numeric keys are used to input a commodity code and a sales amount. The commodity code key is pressed in a case in which the number input through the numeric keys is treated as a commodity code. The clear key is used to cancel an operation at the time of the occurrence of error. The return key is used to cancel the current operation to return to the screen just before the operation. The subtotal key is used to complete the sales registration to declare the calculation of a total amount of sales.

A first display section 15 is a touch panel type display of which the touch panel is laminated on the display surface. The first display section 15 is, for example, a display for operator such as a store clerk of the store. A second display section 16 is arranged on the rear side of the upper surface of the main body housing 13. The second display section 16 is a touch panel type display of which the touch panel is laminated on the display surface thereof. The second display section 16 is, for example, a display for customer who purchases commodities.

The POS terminal 10 includes a printer 17 at the left side of the upper surface of the main body housing 13. The printer 17 prints a receipt and a journal of one transaction to issue them.

The POS terminal 10 includes a card reader/writer 18 in the groove at the right side of the main body housing 13. A card is scanned through the groove to read card information from the card with the card reader/writer 18.

Further, the POS terminal 10 includes a hand-held scanning device 19. The hand-held scanning device 19 is a code reading device for optically reading code information from a barcode attached to a commodity brought by the customer to a settlement counter.

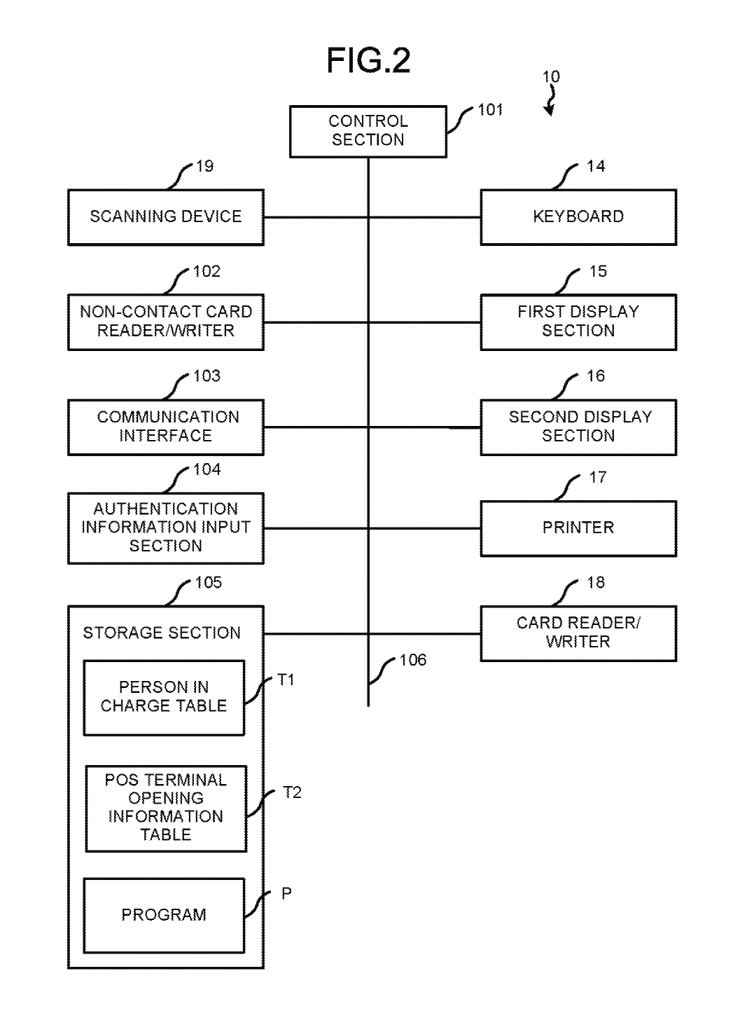

Next, the hardware structure of the POS terminal 10 is described. FIG. 2 is a block diagram illustrating an example of the hardware structure of the POS terminal 10.

The POS terminal 10 is provided with a control section 101 having a computer structure including a CPU, a ROM, and a RAM. The control section 101 is connected with the keyboard 14, the first display section 15, the second display section 16, the printer 17, the card reader/writer 18, the scanning device 19, a non-contact card reader/writer 102, a communication interface 103, an authentication information input section 104 and a storage section 105 via a bus line 106.

The non-contact card reader/writer 102 writes and reads information to/from an IC tag of a non-contact IC card through near-distance wireless communication such as an NFC (Near Field Communication). The communication interface 103 controls communication via an in-store network.

The authentication information input section 104 receives the input of a biometric characteristic of an individual. The authentication information input section 104 receives the input of information for the biometric characteristic of the individual such as a fingerprint, vein, retina, face or the like as a biometric authentication information capable of identifying the individual. Specifically, the authentication information input section 104 captures the biometric characteristic of the individual to receive the input of the biometric authentication information. The authentication information input section 104 may read a physical characteristic or a behavior pattern characteristic as the biometric characteristics. Further, as an example, a case in which the POS terminal 10 of the present embodiment reads the biometric authentication information relating to veins of fingers is described.

The storage section 105 is a storage device such as an HDD (Hard Disk Drive), an SSD (Solid State Drive) and the like. The storage section 105 stores various programs P. The programs P are used to realize functions of an operating system or the POS terminal 10. The programs P contain a program for realizing a characteristic function of the present embodiment. The storage section 105 stores a person in charge table T1 and a POS terminal opening information table T2.

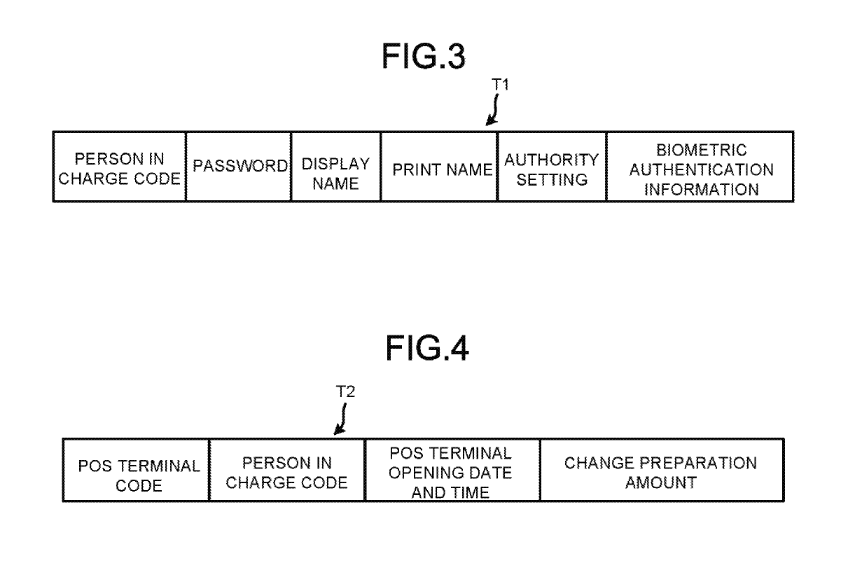

FIG. 3 is a view illustrating an example of the data structure of the person in charge table T1. The person in charge table T1 includes information in which an individual serving as a person in charge of one transaction and various kinds of processing with the POS terminal 10 is registered. The person in charge table T1 stores a person in charge code, a password, a display name, a print name, an authority setting and biometric authentication information in an associated manner. The person in charge code is identification information capable of identifying the individual serving as a person in charge. The password is used to confirm the individual who inputs the person in charge code is the person himself/herself. The display name is a name used at the time of displaying the name of the person in charge on the first display section 15 or the second display section 16. The print name is a name used at the time of printing the name of the person in charge. The authority setting is the setting of authority granted to the person in charge specified with the person in charge code. The biometric authentication information is identification information capable of identifying an individual having the veins of the finger of the person in charge.

FIG. 4 is a view illustrating an example of the data structure of the POS terminal opening information table T2. The POS terminal opening information table T2 stores an execution record of a POS terminal (commodity sales data processing apparatus) opening processing for each POS terminal 10. The POS terminal opening information table T2 stores a person in charge code, a POS code, a POS terminal opening date and time and a change preparation amount in an associated manner. The person in charge code is a record indicating person in charge who executes the POS terminal opening processing. The POS code is identification information capable of identifying the POS terminal 10. The POS terminal opening date and time is a record indicating date and time when the POS terminal opening processing is executed. The change preparation amount is a record indicating prepared change amount at the time of the POS terminal opening processing.

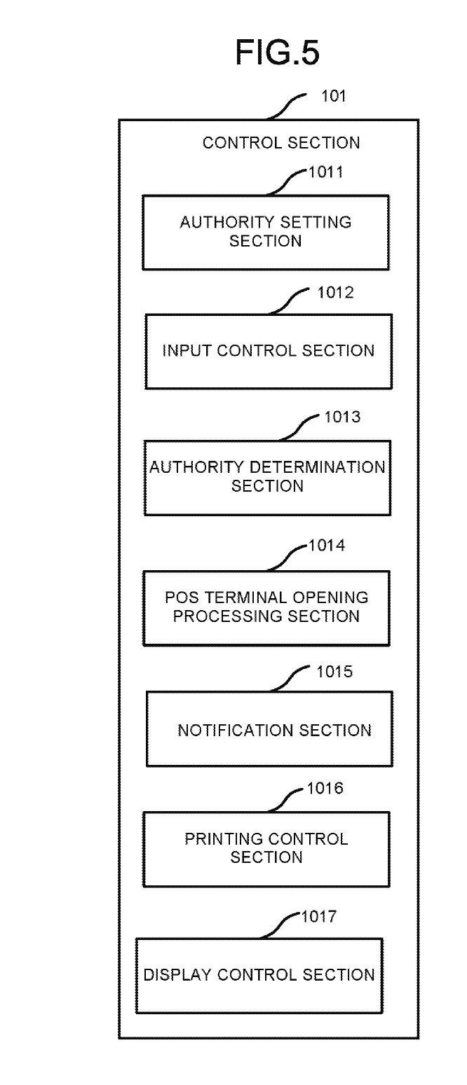

Next, functional components of the POS terminal 10 are described. FIG. 5 is a block diagram indicating the functional components of the POS terminal 10.

The CPU of the control section 101 copies or decompresses the programs P in the storage section 105 on the RAM and operates according to the programs P to generate each function section shown in FIG. 5 on the RAM. Specifically, the control section 101 comprises an authority setting section 1011, an input control section 1012, an authority determination section 1013, a POS terminal opening processing section 1014, a notification section 1015, a printing control section 1016 and a display control section 1017, as functional sections.

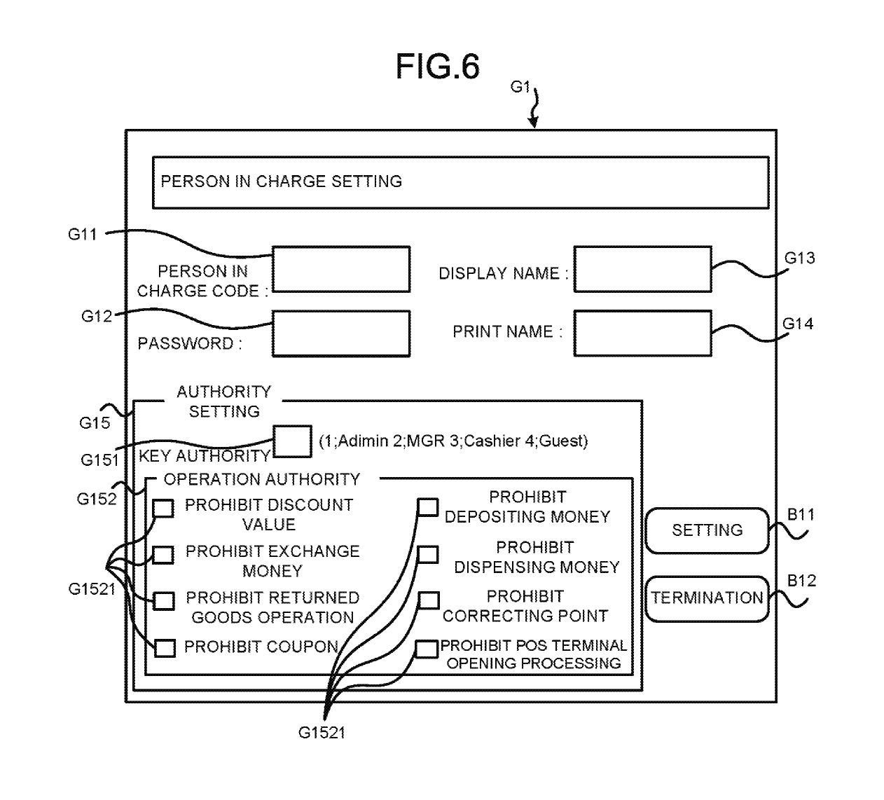

The authority setting section 1011 sets the authority granted to the person in charge who treats one transaction, for using the POS terminal 10. The authority setting section 1011 sets the authority of the individual on the basis of, for example, the setting input to a person in charge setting screen. FIG. 6 is a view illustrating an example of a person in charge setting screen G1. The person in charge setting screen G1 is used to set the grant of the authority to execute the POS terminal opening processing. If the display contents of the person in charge display screen G1 are roughly classified, it includes a person in charge code input column G11, a password input column G12, a display name input column G13, a print name input column G14, an authority setting area G15, a setting button B11 and a termination button B12.

The person in charge code input column G11 is used to input the person in charge code. The password input column G12 is used to input the password for confirming the person in charge. The display name input column G13 is used to input the display name of the person in charge. The print name input column G14 is used to input the print name of the person in charge. The authority setting area G15 is used to set the authority granted to the person in charge specified with the person in charge code.

The authority setting area G15 includes a key authority input column G151 and an operation authority setting area G152. The key authority input column G151 is used to input an operation authority of the person in charge. In the key authority input column G151, any one of authority codes “1”, “2”, “3” and “4” can be input. The authority code refers to authority identification information indicating categories of the authorities. The authority codes are classified, for example, according to a job title, a duty and the like.

Specifically, the authority code “1” represents the grant of authority to execute all the operations. The authority code “2” represents the authority granted to a manager of the store. The POS terminal opening processing can be executed by the person in charge to whom “1” or “2” is set. The authority code “3” represents the authority granted to a general store clerk (cashier) who carries out a commodity sales job, using the POS terminal 10. The authority code “4” represents the authority granted to a person who executes a preset operation as a guest. The operation authority setting area G152 is used to set or select a specific job authority within authorities set in the key authority input column G151. If a specific job authority is selected in the operation authority setting area G152, the execution of a job operation under the selected job authority is prohibited.

The operation authority setting area G152 is used to set the prohibition of execution of a specific job operation by the person in charge. The operation authority setting area G152 includes one or more prohibited job operation check boxes G1521. In the prohibited job operation check boxes G1521, a check mark is put in the check box to select a prohibited job operation. The authority setting section 1011 puts a check mark to a prohibited job operation check box G1521 depending on an authority code set in the key authority input column G151. Then, the authority setting section 1011 can prohibit job operations, for example, a price discount, exchange money, a returned goods operation, a coupon, depositing money, dispensing money, correcting point and a POS terminal opening processing by putting check marks in the prohibited operation check boxes G1521.

If the authority code “1” is set in the key authority input column G151, the authority setting section 1011 sets the authority of executing the POS terminal opening processing for the person in charge specified with the person in charge code. However, if the authority code “3” is set in the key authority input column G151, the check mark is put in the prohibited operation check box G1521 of the POS terminal opening processing in the operation authority setting area G152. Thus, the authority setting section 1011 prohibits the POS terminal opening processing if the authority code “3” is set in the key authority input column G151. Further, in a case in which an operation of removing the check mark in the prohibited operation check box G1521 of the POS terminal opening processing is input via the input control section 1012, the authority setting section 1011 sets the authority of executing the POS terminal opening processing even if the authority code “3” or “4” is set.

The setting button B11 registers the content input to the person in charge setting screen G1 in the person in charge table T1. The termination button B12 terminates the content input to the person in charge setting screen G1 without being registered in the person in charge table T1.

The authority setting section 1011 registers biometric authentication information of each person in charge. Then, the authority setting section 1011 sets, for example, the authority of the individual serving as the person in charge on the basis of the setting input to the biometric authentication setting screen.

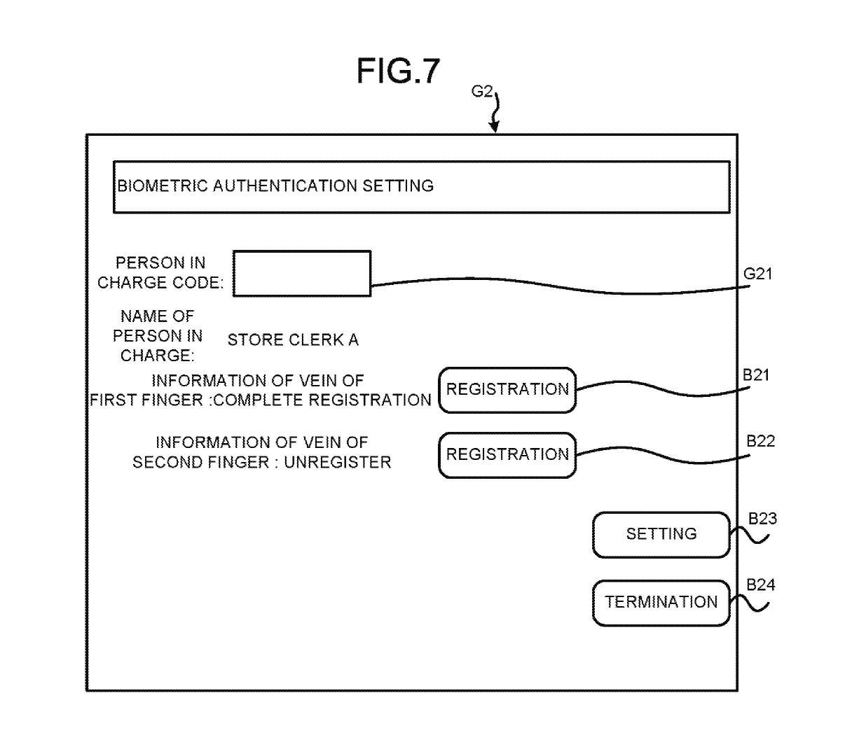

FIG. 7 is a view illustrating an example of a biometric authentication setting screen G2. The biometric authentication setting screen G2 is used to register the biometric authentication information of the person in charge. The biometric authentication information registers, for example, information relating to the veins of the fingers. The biometric authentication setting screen G2 includes a person in charge code input column G21, a first registration button B21, a second registration button B22, a setting button B23 and a termination button B24. The person in charge code input column G21 is used to input the person in charge code of the individual who operates the POS terminal 10. The first registration button B21 is used to register a first biometric authentication information. The second registration button B22 is used to register a second biometric authentication information. In this way, the biometric authentication setting screen G2 can register a plurality of biometric information for each person in charge therethrough. Thus, the POS terminal 10 can authenticate, for example, the person in charge with another finger even if one of the fingers is hurt. The setting button B23 is used to register the content input to the biometric authentication setting screen G2 in the person in charge table T1. The termination button B24 is used to terminate the display of the biometric authentication setting screen G2.

The input control section 1012 controls the keyboard 14 and the touch panel laminated on the first display section 15 or the second display section 16 to receive the input of operating the POS terminal 10. Further, the input control section 1012 serving as an input module receives, for example, the input of the person in charge code from the keyboard 14 or the touch panel. Alternatively, the input control section 1012 controls the authentication information input section 104 to receive the input of the biometric authentication information.

The authority determination section 1013 determines whether or not the individual who is going to execute the POS terminal opening processing has the authority to execute the POS terminal opening processing before the execution of the POS terminal opening processing using the POS terminal opening processing section 1014. Specifically, the authority determination section 1013 determines whether or not the individual specified with the person in charge code or the biometric authentication information input from the input control section 1012 is registered in the person in charge table T1 before the execution of the POS terminal opening processing. If the individual is registered in the person in charge table T1, the authority determination section 1013 refers to the authority setting in the person in charge table T1 to determine whether or not the individual has the authority to execute the POS terminal opening processing. Then, if the individual has the authority to execute the POS terminal opening processing, the authority determination section 1013 serving as the storage control module stores the person in charge code of the individual who executes the POS terminal opening processing in the POS terminal opening information table T2.

The POS terminal opening processing section 1014 serving as the POS terminal opening processing module executes the POS terminal opening processing if the authority determination section 1013 determines that the individual has the authority to execute the POS terminal opening processing. The POS terminal opening processing refers to a processing of preparing the POS terminal 10 to a state in which the transaction can be performed. For example, the POS terminal opening processing refers to a job including the input of the POS terminal opening date and time and the registration of change supplied to the drawer 11 of the POS terminal 10. Specifically, the POS terminal opening processing section 1014 registers the POS terminal opening date and time received by the input control section 1012 in the POS terminal opening information table T2. Further, the POS terminal opening processing section 1014 registers the change preparation amount received by the input control section 1012 in the POS terminal opening information table T2. The POS terminal opening processing section 1014 does not execute the POS terminal opening processing if the person in charge code is not registered in the person in charge table T1 or if the authority determination section 1013 determines that the individual has no authority to execute the POS terminal opening processing. The POS terminal opening date and time in the POS terminal opening processing may be the input of only POS terminal opening date or the input of only POS terminal opening time. Further, the POS terminal opening processing may contain a processing and jobs other than the input of the POS terminal opening date and time and the input of the change preparation amount.

The notification section 1015 carries out a notification operation if the individual has no authority to execute the POS terminal opening processing through the POS terminal opening processing section 1014. Specifically, the notification section 1015 notifies that the input person in charge code is not registered if the person in charge code input from the input control section 1012 is not registered in the person in charge table T1. Alternatively, the notification section 1015 carries out the notification operation if the individual specified with the person in charge code input from the input control section 1012 has no authority to execute the POS terminal opening processing using the POS terminal opening processing section 1014. Further, no limitation is given to the notification method. For example, the notification section 1015 carries out the notification operation by displaying a notification screen (not shown). Alternatively, the notification section 1015 carries out the notification operation with sound.

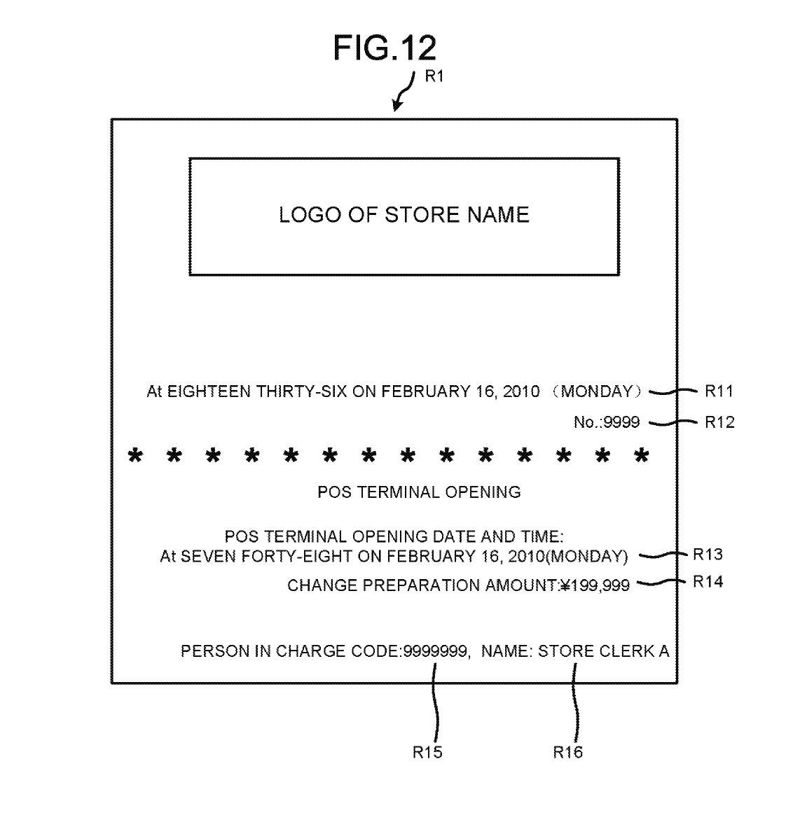

The printing control section 1016 controls the printer 17 to print the receipt. Specifically, the printing control section 1016 serving as the output module controls the printer 17 to print out a POS terminal opening receipt R1 (refer to FIG. 12). The POS terminal opening receipt R1 refers to a paper on which information relating to the POS terminal opening processing executed through the POS terminal opening processing section 1014 is printed.

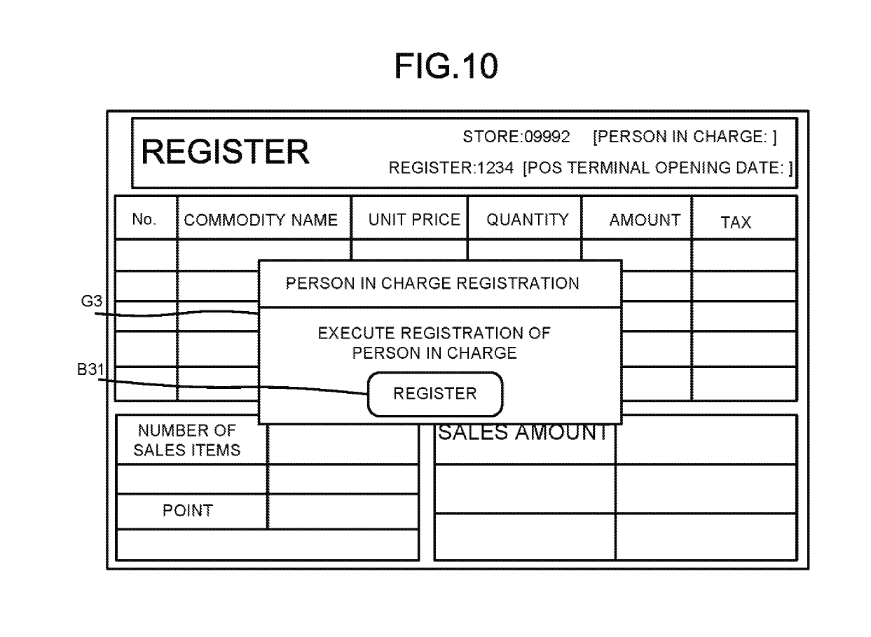

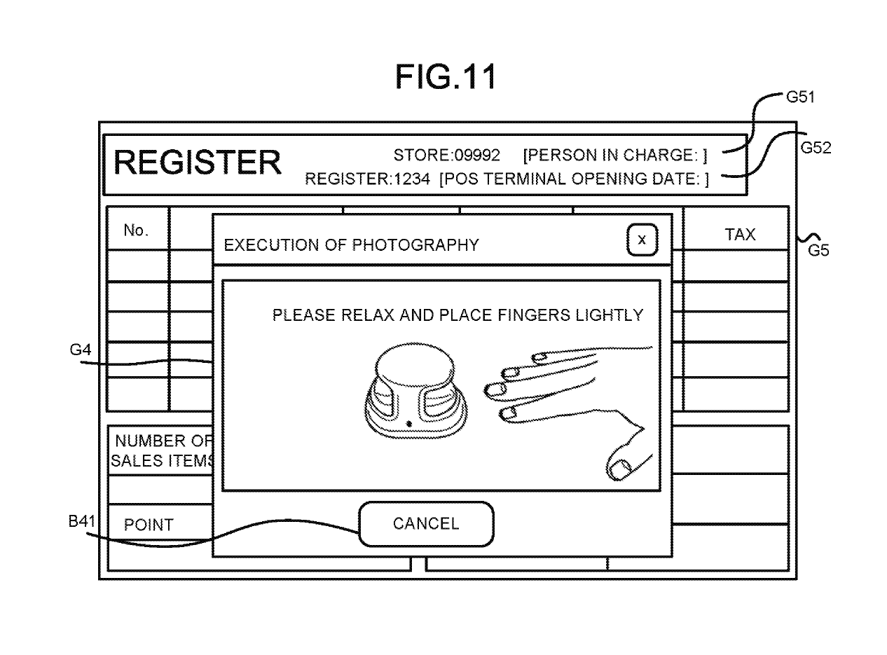

The display control section 1017 controls the screens displayed on the first display section 15 and the second display section 16. Specifically, the display control section 1017 serving as the display control module controls the first display section 15 and the second display section 16 to display the person in charge setting screen G1, the biometric authentication setting screen G2, a person in charge registration screen G3 (refer to FIG. 10), a biometric authentication information input screen G4 (refer to FIG. 11) and a POS terminal opening processing screen G5 (refer to FIG. 11).

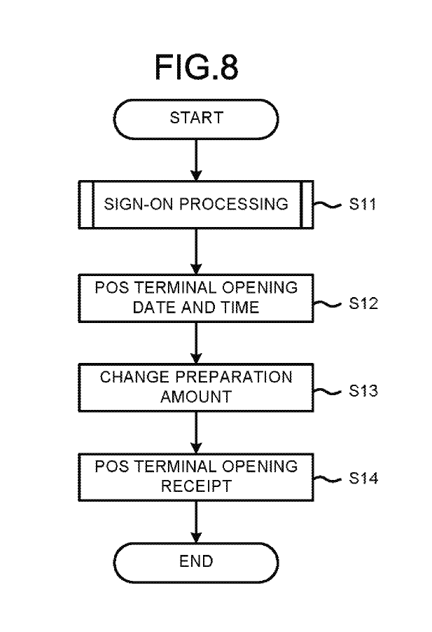

Next, the foregoing POS terminal opening processing executed by the POS terminal 10 of the embodiment is described. FIG. 8 is a flowchart illustrating the flow of the POS terminal opening processing executed by the POS terminal 10.

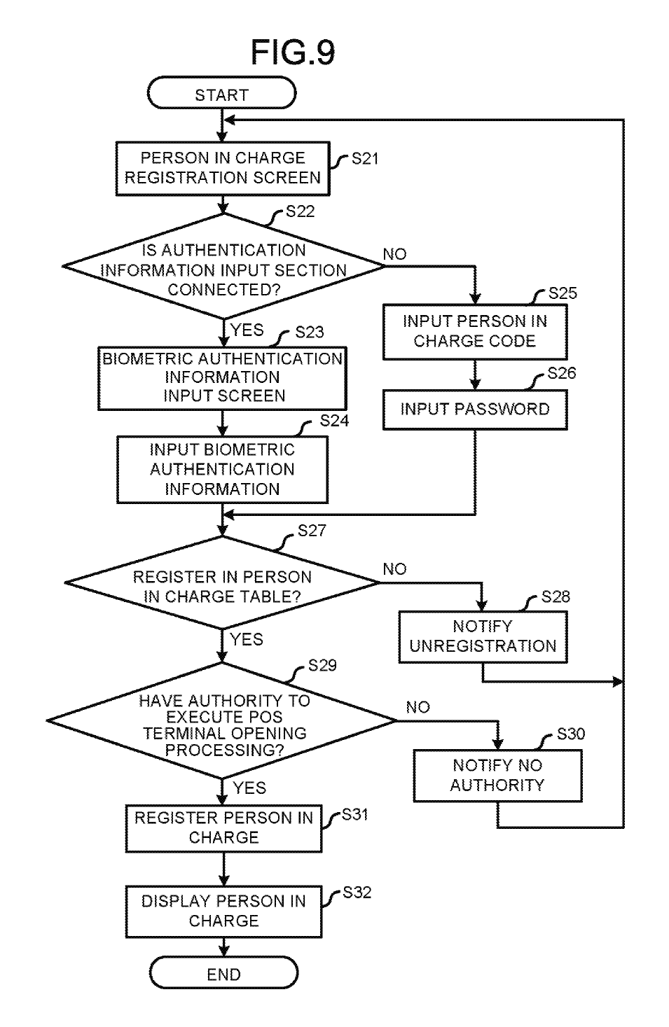

First, the control section 101 of the POS terminal 10 executes a sign-on processing (Act S11). FIG. 9 is a flowchart illustrating the flow of the sign-on processing executed by the POS terminal 10.

The control section 101 (display control section 1017) of the POS terminal 10 controls the first display section 15 to display the person in charge registration screen G3 (Act S21).

FIG. 10 is a view illustrating an example of the person in charge registration screen G3. The person in charge registration screen G3 displays a message “carry out the registration of the person in charge” to notify the individual of the registration as the person in charge. Further, the person in charge registration screen G3 includes a registration button B31 for starting the sign-on processing.

If the registration button B31 is pressed, the control section 101 (input control section 1012) of the POS terminal 10 determines whether or not the authentication information input section 104 is connected with the POS terminal 10 (Act S22).

If the authentication information input section 104 is connected with the POS terminal 10 (Yes in Act S22), the control section 101 (display control section 1017) of the POS terminal 10 controls the first display section 15 to display the biometric authentication information input screen G4 (Act S23).

FIG. 11 is a view illustrating an example of the biometric authentication information input screen G4. The biometric authentication information input screen G4 displays an image indicating a method of reading the veins of the fingers and a message “please relax and place fingers lightly”. In this way, the biometric authentication information input screen G4 instructs the input of the biometric authentication information through the authentication information input section 104. The biometric authentication information input screen G4 includes a cancel button B41 for cancelling the sign-on processing.

The biometric authentication information input screen G4 further includes the POS terminal opening processing screen G5 as a background. The POS terminal opening processing screen G5 includes a person in charge display area G51 and a POS terminal opening date display area G52. The person in charge display area G51 displays the display name of the person in charge registered through the POS terminal opening processing. The POS terminal opening date display area G52 displays a POS terminal opening day registered through the POS terminal opening processing.

In the biometric authentication information input screen G4, the control section 101 (input control section 1012) of the POS terminal 10 receives the input of the biometric authentication information (Act S24).

If the authentication information input section 104 is not connected with the POS terminal 10 (No in Act S22), the control section 101 (input control section 1012) of the POS terminal 10 receives the input of the person in charge code (Act S25). Next, the control section 101 (input control section 1012) of the POS terminal 10 receives the input of the password associated with the person in charge code (Act S26).

Next, the control section 101 (authority determination section 1013) of the POS terminal 10 determines whether or not the input person in charge code or biometric authentication information is registered in the person in charge table T1 (Act S27).

If the person in charge code or the biometric authentication information is not registered in the person in charge table T1 (No in Act S27), the control section 101 (notification section 1015) of the POS terminal 10 notifies that the person in charge code or the biometric authentication information of the person is not registered in the person in charge table T1 (Act S28). Then, the control section 101 of the POS terminal 10 proceeds to the processing in Act S21.

On the other hand, the person in charge code or the biometric authentication information is registered in the person in charge table T1 (Yes in Act S27), the control section 101 (authority determination section 1013) of the POS terminal 10 determines whether or not the person in charge indicated by the input person in charge code or the biometric authentication information has the authority to execute the POS terminal opening processing (Act S29).

If the person in charge has no authority to execute the POS terminal opening processing (No in Act S29), the control section 101 (notification section 1015) of the POS terminal 10 notifies that the person in charge has no authority to execute the POS terminal opening processing (Act S30). Then, the control section 101 of the POS terminal 10 proceeds to the processing in Act S21.

On the other hand, if the person in charge has the authority to execute the POS terminal opening processing (Yes in Act S29), the control section 101 (authority determination section 1013) of the POS terminal 10 registers the information relating to the person in charge who executes the POS terminal opening processing in the POS terminal opening information table T2 (Act S31). Specifically, if the person in charge code is input, the control section 101 (authority determination section 1013) of the POS terminal 10 registers the input person in charge code in the POS terminal opening information table T2. On the other hand, if the biometric authentication information is input, the control section 101 (authority determination section 1013) of the POS terminal 10 registers the person in charge code which is associated with the input biometric authentication information in the person in charge table T1 in the POS terminal opening information table T2.

Next, the control section 101 (display control section 1017) of the POS terminal 10 displays the person in charge specified with the person in charge code registered in the POS terminal opening information table T2 on the POS terminal opening processing screen G5 (Act S32). Specifically, the control section 101 (display control section 1017) of the POS terminal 10 displays the display name in the person in charge table T1 associated with the person in charge code registered in the POS terminal opening information table T2 on the person in charge display area G51.

As stated above, the control section 101 of the POS terminal 10 terminates the sign-on processing.

Return to FIG. 8, if the sign-on processing is terminated, the control section 101 (POS terminal opening processing section 1014) of the POS terminal 10 registers the input POS terminal opening date and time (Act S12).

Next, the control section 101 (POS terminal opening processing section 1014) of the POS terminal 10 registers the input change preparation amount (Act S13).

Next, the control section 101 (printing control section 1016) of the POS terminal 10 prints the POS terminal opening receipt R1 (Act S14).

FIG. 12 is a view illustrating an example of the POS terminal opening receipt R1. The POS terminal opening receipt R1 includes a POS terminal opening receipt issuing date and time R11, a POS terminal opening receipt identification number R12, a POS terminal opening date and time R13, a change preparation amount R14, a person in charge code R15 and a name of person in charge R16. The POS terminal opening receipt issuing date and time R11 refers to an issuing date and time when the POS terminal opening receipt R1 is issued. The POS terminal opening receipt identification number R12 refers to identification information capable of identifying the POS terminal opening receipt R1. The POS terminal opening date and time R13 refers to POS terminal opening date and time information serving as a date and time when the POS terminal opening processing is executed. The change preparation amount R14 refers to change preparation amount information serving as a change amount prepared at the time of the POS terminal opening processing. The person in charge code R15 refers to the person in charge code of the person who executes the POS terminal opening processing. The name of person in charge R16 refers to the print name of the person who executes the POS terminal opening processing.

As stated above, the control section 101 of the POS terminal 10 terminates the POS terminal opening processing.

As stated above, according to the POS terminal 10 of the present embodiment, the input control section 1012 receives the input of the identification information such as the person in charge code or the biometric authentication information capable of identifying the individual. Then, the authority determination section 1013 determines whether or not the individual identified by the identification information input from the input control section 1012 has the authority to execute the POS terminal opening processing before the execution of the POS terminal opening processing. If the individual has no authority to execute the POS terminal opening processing, the notification section 1015 carries out the notification operation. On the other hand, if the individual has the authority to execute the POS terminal opening processing, the authority determination section 1013 stores the identification information in the POS terminal opening information table T2. The POS terminal opening processing section 1014 executes the POS terminal opening processing. Thus, the individual who is determined to have the authority to execute the POS terminal opening processing can be stored. Further, the POS terminal 10 of the present embodiment can record the person in charge who prepares the change preparation amount by executing the sign-on processing before the execution of the POS terminal opening processing, thereby suppressing an unfair action.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

Further, in the foregoing embodiment, it is described that the POS terminal 10 prints out the information such as the person in charge code of the individual, who executes the POS terminal opening processing, stored in the POS terminal opening information table T2 or displays the information on the POS terminal opening processing screen G5. However, the POS terminal 10 may output the information such as the person in charge code of the individual, who executes the POS terminal opening processing, stored in the POS terminal opening information table T2 with another modification. For example, the POS terminal 10 may output the information such as the person in charge code of the individual, who executes the POS terminal opening processing, stored in POS terminal opening information table T2 to another device via the communication interface 103. Alternatively, the POS terminal 10 may output the information such as the person in charge code of the individual, who executes the POS terminal opening processing, stored in POS terminal opening information table T2 to another recording medium.

What is claimed is:

1. A commodity sales data processing apparatus, comprising:
an input module configured to receive an input of identification information capable of identifying an individual;
a commodity sales data processing apparatus opening processing module configured to execute a commodity sales data processing apparatus opening processing in a case in which an individual specified with identification information input from the input module has authority to execute the commodity sales data processing apparatus opening processing; and
a storage control module configured to enable a storage section to store the identification information of the individual who executes the commodity sales data processing apparatus opening processing through the commodity sales data processing apparatus opening processing module.

2. The commodity sales data processing apparatus according to claim 1, further comprising
an output module configured to output the identification information of the individual, who executes commodity sales data processing apparatus opening processing, stored in the storage section.

3. The commodity sales data processing apparatus according to claim 2, wherein
the output module prints out the identification information of the individual on a commodity sales data processing apparatus opening processing receipt indicating information relating to the commodity sales data processing apparatus opening processing executed by the commodity sales data processing apparatus opening processing module.

4. The commodity sales data processing apparatus according to claim 1, wherein
the input module receives the input of biometric characteristic of the individual as the identification information.

5. The commodity sales data processing apparatus according to claim 1, further comprising
a display control module configured to display a setting screen for setting the identification information and authority identification information indicating categories of authorities to grant the authority to execute the commodity sales data processing apparatus opening processing.

6. A method for executing a commodity sales data processing apparatus opening processing, including:
receiving an input of identification information capable of identifying the individual;
executing a commodity sales data processing apparatus opening processing in a case in which an individual specified with the input identification information has authority to execute the commodity sales data processing apparatus opening processing; and
storing the identification information of the individual who executes the commodity sales data processing apparatus opening processing.
